(19) United States
(12) Patent Application Publication
(10) Pub. No.: US 2006/0135564 A1
(43) Pub. Date: Jun. 22, 2006

(54) Insecticidal compositions comprising compounds having inhibitory activity versus acyl coa: cholesterol acyltransferase or salts thereof as effective ingredients

(76) Inventors: Young-Kook Kim, Taejeon-si (KR); Hyun-sun Lee, Taejeon-si (KR); Mun-Chual Rho, Taejeon-si (KR); Sung-Uk Kim, Jugon (KR)

Correspondence Address: BOZICEVIC, FIELD & FRANCIS LLP, 1900 UNIVERSITY AVENUE, SUITE 200, EAST PALO ALTO, CA, 94303, US

(21) Appl. No.: 10/541,639

(22) PCT Filed: Dec. 11, 2003
(86) PCT No.: PCT/KR03/02711

§ 371 Date: Jan. 23, 2006

(30) Foreign Application Priority Data
Jan. 7, 2003 (KR) 10-2003-000825

(51) Int. Cl. A01N 43/32; A01N 43/40

(52) U.S. Cl. 514/337; 514/452

(57) ABSTRACT

The present invention relates to insecticidal compositions comprising compounds having an inhibitory activity versus acyl CoA:cholesterol acyltransferase (ACAT) or salts thereof as effective ingredients. The compounds having inhibitory activity versus ACAT have an excellent insecticidal effect by inhibiting sterol metabolism in noxious insects. Therefore, the compounds of the present invention can be used as safe and effective insecticides.

### TECHNICAL FIELD

The present invention relates to the concept that some compounds and their salts having inhibitory effect on acyl CoA:cholesterol acyltransferase (ACAT) activity can be used for insecticides.

### BACKGROUND ART OF THE INVENTION

Synthetic organic insecticides were widely used for improving production yields of agricultural crops, eliminating noxious insects, particularly in forests. However, continuous use and abuse of these insecticides for several decades has resulted in destruction of biological protection systems using natural enemies, abnormal occurrence of noxious insects or the development of a resistance to the insecticides, development of toxicity in non-target organisms including humans, environmental contamination, etc.

Due to their adverse effects, the synthetic organic insecticides have been gradually reduced in use, and, in particular, their domestic use will be reduced to 50% in 2004, compared to their use in 1993. Therefore, there is an urgent need for the development of new insecticides as a tool for enhancing the yields of agricultural products. Also, the size of the world market for biological preparations is estimated to enlarge to over 5 trillion Korean won, and the size of the domestic market for biological insecticides is also expected to enlarge to about 94 billion Korean won. Moreover, with advances in bioengineering techniques, such enlargement of insecticide markets will be realized.

Insecticides penetrate insects via the mouth, skin and spiracle. When insecticides arrive at their targets in insects, some of them are degraded and nontoxic, while others are activated, become more toxic and are accumulate in organs or excreted to the outside of the body. When an insecticide is applied to insects, only a part of the used insecticide displays its insecticidal activity in its target. Typically, since there are several resistant factors for the insecticide to arrive at its target in the body of the insects, only a portion of the used insecticide arrives its action site and then destroys physiological and biochemical functions of the insects, eventually killing the insects. Therefore, when using or developing insecticides, their action sites and action mechanisms and metabolism affecting their effective concentrations in the body of the insects should be deeply considered.

The currently available insecticides are classified by mode of action into nerve poisons but they affect the transmission of nerve impulses along the axon, energy production inhibitors, insect growth regulators and sex-attract pheromones. The insect growth regulators are subgrouped into juvenile hormone inhibitors and chitin synthesis inhibitors.

The nerve poisons kill insects by abnormally stimulating, exciting or inhibiting the nervous system.

A neuron, the minimal unit that constitutes the nervous system, has usually one long thin fiber projecting from the cell body, called an axon. At the axon terminal, the axon makes a contact to the dendrite of another neuron while forming a specialized structure called “synapse”. A nerve impulse propagates along an axon. When the nerve impulse reaches the axon terminal, a neurotransmitter, acetylcholine (hereinafter, referred to as “ACh”) is immediately released from the synaptic vesicles into the synapse between presynaptic and postsynaptic membranes. The released ACh binds to its receptor in the postsynaptic membrane, resulting in stimulation of the postsynaptic neuron. In this way, a nerve impulse is transmitted from one neuron to another neuron.

Immediately after transmitting the nerve impulse from the presynaptic membrane to the postsynaptic membrane, the ACh released from the synaptic vesicles is hydrolyzed by acetylcholinesterase (hereinafter, referred to as “AChE”) that is released from the postsynaptic membrane. AChE has two kinds of activities: one is to have a site responsible for degradation of negatively charged ions and esters, and the other is to hydrolyze ACh.

Therefore, when ACh is accumulated at the postsynaptic membrane in a state of binding to its receptor after transmission of the nerve impulse to the postsynaptic neuron, hyper excitability and convulsions can be caused. Therefore, ACh is converted to choline and acetic acid by action of AChE. The choline is taken into the presynaptic membrane for re-use and converted to ACh in the synaptic vesicles.

In this regard, when insecticides inhibiting the activity of AChE acting to degrade ACh, which are mainly organophosphates and carbamates, are used for controlling insects, ACh becomes accumulated in the synapse, and nerve impulse transmission becomes abnormal, thereby causing convulsions, paralysis and eventually death. The organophosphate and carbamate insecticides are known to inhibit ACh degradation by mainly acting to the active site of AChE.

These chemicals relatively rapidly penetrate insects through the skin, attach to the surface of the nervous system, and lead to malfunction of the nerve impulse transmitting system and, after a certain latent period, the symptoms of abnormal behavior, excessive nervous activity, severe convulsions and finally paralysis and death.

The insect growth regulators kill insects by interfering with chitin synthesis and thus construction of the insect cuticle, and classified into juvenile hormone inhibitors and chitin synthesis inhibitors.

Typically, insects detoxify absorbed insecticides by metabolizing them by various enzymes associated with oxidation, reduction, hydrolysis, and the like. However, some insecticides obtain much higher toxicity by metabolism. This change is called “activation”, and insecticides are activated by mainly oxidation reactions.

Insects have a hardened external body wall (exoskeleton) as the skin. Unlike the skin of vertebrates, the exoskeleton of insects has structural functions, such as body shape maintenance, muscle support and hardness, and has a different chemical composition. The exoskeleton (or cuticle) must be shed for insects to grow. Thus, formation of the cuticle is very important in the growth of insects. The insect's exoskeleton (skin) is a multilayered structure with three functional regions: cuticle, epidermis, and basement membrane. The cuticle can be divided into two layers: the epicuticle and the procuticle. Chitin, which is not found in vertebrates, is the main component of the cuticle. Chitin synthesis is a major target when intending to kill insects, and inhibited especially by insecticides acting to inhibit the shedding of insects, which finally kills the insects.

The procuticle of the insect's exoskeleton contains a large amount of chitin that is a linear polymer of N-acetyl glucosamine units. Unlike nerve poisons, when molting inhibitors are introduced into insects through their mouth or stigma, the cuticle of the insects is not formed normally, and the insect's molting is thus blocked. Herein, the molting inhibitors inhibit the biosynthesis of chitin in an inner endocuticle layer in the procuticle while not affecting formation of the epicuticle composed of hardened proteins. Although their detailed action mechanisms are not identified, the molting inhibitors are known to inhibit an enzyme associated with the biosynthesis of chitin that is a main component of the proculticle by inhibiting polymerization of UDP-N-acetyl glucosamine.

Sex-attractant pheromones are also used to kill insects. Typically, male insects are captured using male-attracting pheromones released by female insects, and finally killed. However, the sex-attractant pheromones are not effective in the field.

Some insecticides act to physically suffocate pests by covering their skin using machine oil emulsions. However, the currently used insecticides mostly affect the nervous system or enzymes associated with energy production, which are essential for maintaining the insect's life. In particular, insecticides attacking functions specific for insects, for example, by inhibiting the biosynthesis of chitin forming the cuticle layer or by blocking production of juvenile hormones, have been developed and put to practical use.

The physiology of insects has been partially reported by many researchers. Recent studies have focused on metabolism-associated enzymes or receptors by means of the molecular biological methods.

As a result of such studies, cholesterol is, in insects, required for the formation of plasma membrane and waxes on the cuticle and lipid transport in the blood or lymph. Cholesterol can be replaced with 22-dehydrocholesterol or 7-dehydroergosterol, and the compounds are thus called “alternate compounds”. However, the alternate compounds cannot be used for synthesis of the insect molting hormones.

Lipid components are poorly hydrophilic in insects and thus not easily transferred between tissues via the blood or lymph. Insects overcome this problem by using transport proteins. Phospholipids, cholesterol, hydrocarbons, juvenile hormones and even lipid materials originating from diets or introduced through the body wall are carried in a state of binding to the transport proteins.

In particular, juvenile hormones are present in a state of binding to transport or binding proteins in the blood or lymph. The binding proteins serve as vehicles for juvenile hormones, as well as acting to prevent juvenile hormones from being attacked by non-specific esterases. However, juvenile hormone-specific esterases can degrade juvenile hormones regardless to their biding to the binding proteins. Therefore, juvenile hormone titer in the blood or lymph is determined according to their amount released by the corpus allatum and the activity of juvenile hormone esterases.

The corpus allatum secreting juvenile hormones shows periodic activity during larval development and reproduction in adult stages, and its high activity to secrete the hormones has a close relation with its change in volume. In high activity, the corpus allatum cells secreting the hormones are enlarged with an increase of intracellular organelles in the cytosol. Some reports revealed that the insect juvenile hormones suppress metamorphosis of insects and insects thus molt when juvenile hormone titer is lowered.

Many researchers have studied the physiology of insects, especially, metabolism-associated enzymes or receptors, by using the molecular biological techniques. However, hormone transport and sterol storage were rarely studied.

Because insects are unable to synthesize sterols, they require sterols as essential nutrients. Most insects use plant sterols by converting them into cholesterol. Cholesterol is required for the biosynthesis of molting hormones, as well as participating in the formation of the plasma membrane together with phospholipids.

On the other hand, acyl CoA:cholesterol acyltransferase inhibitors are known to have the effects of preventing and treating hypertension in humans. In particular, they are under development as a therapeutic agent for hypertension, which has a new action mechanism related with a mechanism of the onset of arteriosclerosis. Acyl CoA:cholesterol acyltransferase, which catalyzes acylation of cholesterol, participates in the absorption of cholesterol in the small intestine, synthesis of VLDLs (very low density lipoproteins) in the liver and the accumulation of cholesterol in an acylated form in adipose tissue and the blood vessel walls. Also, Acyl CoA:cholesterol acyltransferase is known to involve the progress of arteriosclerosis, and is used as a target for the development of hypertension therapeutic agents with a new action mode. Representative examples of the acyl CoA:cholesterol acyltransferase inhibitors include chemically synthesized urea, amides and phenols. Among them, some drug candidates passed in vivo activity tests are in preclinical trials for use as therapeutic agents for arteriosclerosis. However, to date, there has been no report regarding the clinical application of the acyl CoA:cholesterol acyltransferase inhibitors.

Based on the fact that insects essentially require sterols for growth and reproduction, the present inventors found that insects are killed when a sterol-acylating enzyme participating in storage or transport of sterols is inhibited, and developed novel safe insecticides, which are capable of killing insects by the newly identified action mechanism.

### SUMMARY OF THE INVENTION

Leading to the present invention, with the introduction of a new concept of inhibiting target, a sterol-acylating enzyme, known to play a critical role in production of sterols for storage or various hormones during sterol metabolization in the larval stage of insects, the present inventors explored, isolated and purified novel compounds with insecticidal activity from natural sources, and determined their molecular structures. The isolated compounds and other synthetic organic compounds were analysed whether they have inhibitory effect on acyl CoA:cholesterol acyltransferase activity using an assay system of the present invention. Insecticidal assays against two larval insects resulted in the finding that the compounds, identified to have an inhibitory activity on the aforementioned enzyme, have an effect of killing the larvae.

It is therefore an object of the present invention to provide the concept that compounds having an inhibitory effect on acyl CoA:cholesterol acyltransferase activity or salts can be used as effective ingredients of an insecticide.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a ¹H-NMR spectrum of pyripyropene A (Formula 1) of the present invention;

FIG. 2 is a ¹H-NMR spectrum of phenylpyropene A (Formula 2) of the present invention;

FIG. 3 is a ¹H-NMR spectrum of phenylpyropene B (Formula 3) of the present invention;

FIG. 4 is a ¹H-NMR spectrum of phenylpyropene C (Formula 4) of the present invention;

FIG. 5 is a ¹H-NMR spectrum of pheophorbide a (Formula 5) of the present invention;

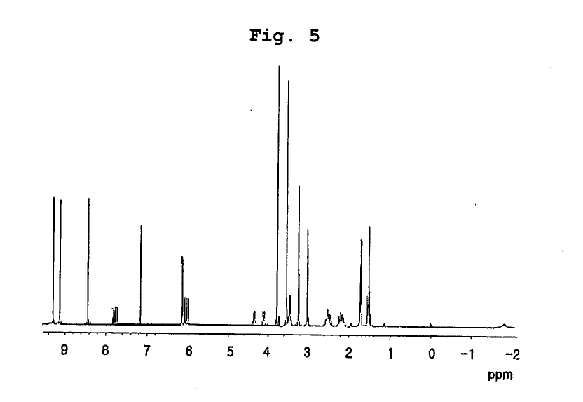

FIG. 6 is a graph showing an insecticidal effect of pyripyropene A of the present invention against Plutella xylostella L larvae;

FIG. 7 is a graph showing insecticidal effects of the compounds of Formulas 5 to 11 of the present invention against Plutella xylostella L larvae;

FIG. 8 is a graph showing larval weight-reducing effects of phenylpyropene A, B and C of the present invention against Tenebrio molitor L larvae; and

FIG. 9 is a photograph showing insecticidal activity of pyripyropene A, phenylpyropene A and C and pheophorbide a according to the present invention against Tenebrio molitor L larvae, where the degree of growth of the larvae is compared with that of a control.

### DETAILED DESCRIPTION OF THE INVENTION

In order to achieve the aforementioned object, the present invention provides an insecticidal composition comprising compounds having an inhibitory effect on acyl CoA:cholesterol acyltransferase or salts thereof as effective ingredients.

The present invention will be in detail described, below.

The present invention provides an insecticidal composition comprising a compound having an inhibitory activity on acyl CoA:cholesterol acyltransferase or a salt thereof as an effective ingredient. In detail, the present invention provides an insecticidal composition comprising as an effective ingredient a compound selected from the group consisting of compounds represented by Formulas 1 to 11, below.

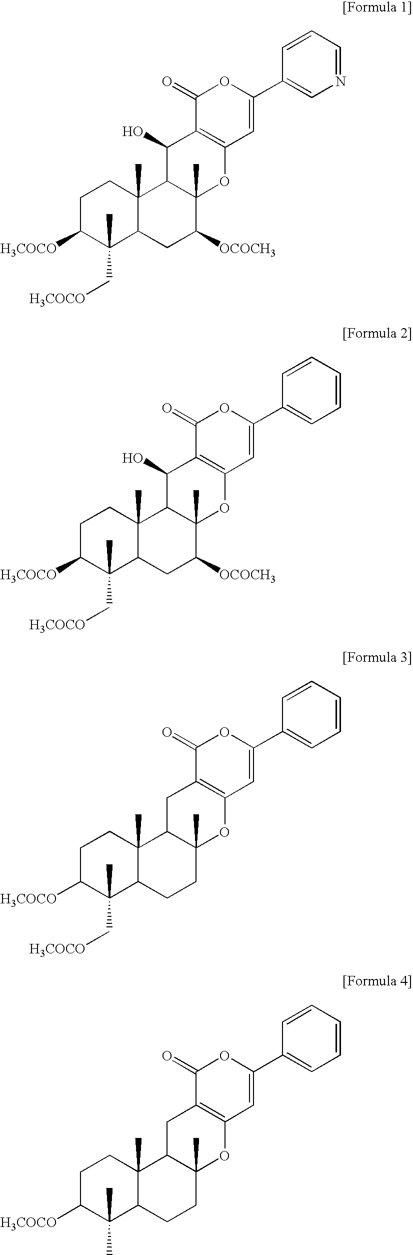

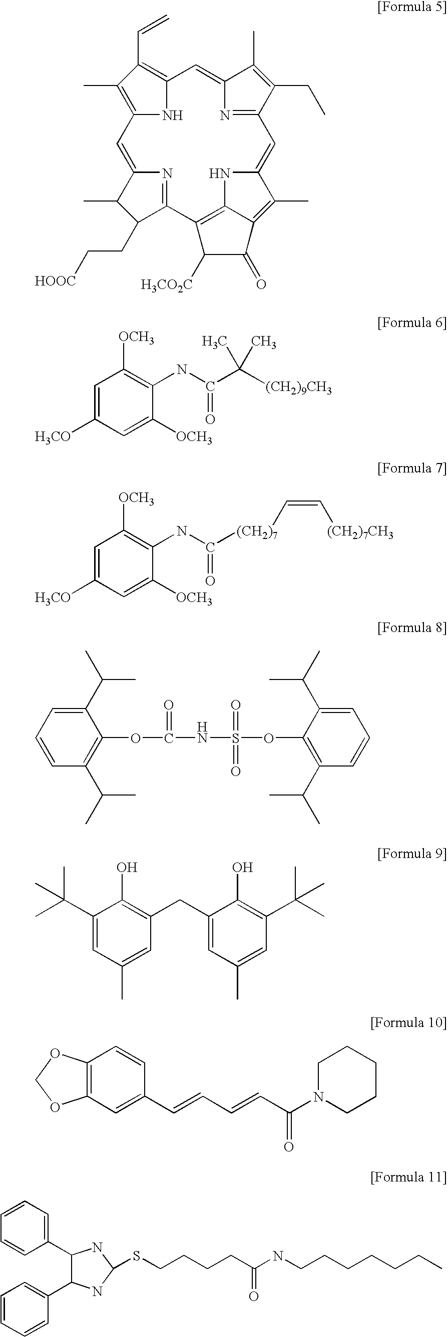

The compounds of the Formulas 1 to 11 may be obtained by chemical synthesis or extraction from plants or microorganisms.

Among the present compounds, the compounds of the Formulas 1 to 4 are prepared by a process comprising culturing Penicillium griseofulvum F1959, extracting the cultured cells with ethyl acetate and chromatographing the resulting extract.

The ethyl acetate extract obtained from the Penicillium griseofulvum F1959 was chromatographed to obtain the compounds of the Formulas 1 to 4. In the chromatography step, preferably, silica gel column chromatography is performed, followed by high-speed liquid chromatography. Preferably, a mixture of chloroform and methanol is used as a solvent in the silica gel column chromatography, and a mixture of acetonitrile and water is used as a solvent in the high-speed liquid chromatography.

The compounds of the Formulas 1 to 11 have an inhibitory activity versus acyl. CoA:cholesterol acyltransferase, and possess an insecticidal activity against larval insects due to such an inhibitory activity.

In the experimental examples to be described later, based on the fact that insects essentially require sterols for their growth and essentially utilize a sterol-acylating enzyme participating in the storage and transport of sterols and activation and destruction of hormones, the compounds of the present invention were evaluated for an insecticidal effect. The compounds were found to have an insecticidal activity by inhibiting acyl CoA:cholesterol acyltransferase that participates in the storage and transport of sterols during sterol metabolization.

The compounds of the present invention, which have an inhibitory activity versus acyl CoA:cholesterol acyltransferase, may have the effects of controlling noxious insects including harmful arthropods (e.g., harmful insects and harmful mites) and harmful nematodes. In addition, the compounds of the present invention may be used for effectively controlling noxious insects having enhanced resistance to the conventional insecticides.

In case of being used as effective ingredients of an insecticidal composition, the compounds of the present invention, with no addition of other ingredients, may be used in the form as they are or of a salt thereof (an agrochemically acceptable salt with an inorganic acid such as hydrochloric acid or sulfuric acid, or an organic acid such as p-toluenesulfonic acid). However, the compounds of the present invention are typically mixed with solid carriers, liquid carriers, gaseous carriers or baits, or absorbed into base materials, for example, porous ceramic plates or nonwoven fabrics, added with surfactants and, if necessary, other additives, and then formulated into a variety of forms, for example, oil sprays, emulsified concentrates, wettable powders, well-flow granules, dusts, aerosols, fuming preparations such as fogging, evaporable preparations, smoking preparations, poisonous baits, and sheet or resin preparations for controlling mites.

Each of the above formulations may contain one or more of the compounds of the present invention as effective ingredients in an amount of 0.01 to 95% by weight.

The solid carriers usable in the formulations may include fine powders or granules of clays (e.g., kaolin clay, diatomaceous earth, bentonite, fubasami clay and acid clay), synthetic hydrated silicon oxide, talcs, ceramics, other inorganic minerals (e.g., silicate, quartz, sulfur, active carbon, calcium carbonate and hydrated silica), and chemical fertilizers (e.g., ammonium sulfate, ammonium phosphate, ammonium nitrate, urea and ammonium chloride).

The liquid carriers may include water, alcohols (e.g., methanol, ethanol, etc.), ketones (e.g., acetone and methyl ethyl ketone), aromatic hydrocarbons (e.g., toluene, xylene, ethylbenzene and methylnaphthalene), aliphatic hydrocarbons (e.g., hexane, cyclohexane, kerosene and light oil), esters (e.g., ethyl acetate and butyl acetate), nitriles (e.g., acetonitrile and isobutyronitrile), ethers (e.g., diisopropyl ether and dioxane), acid amides (e.g., N,N-dimethylformamide and N,N-dimethylacetamide), halogenated hydrocarbons (e.g., dichloromethane, trichloroethane and carbon tetrachloride), dimethyl sulfoxide, and vegetable oils (e.g., soybean oil and cottonseed oil).

The gas carriers or propellants may include Freon gas, butane gas, LPG (liquefied petroleum gas), dimethyl ether and carbon dioxide gas.

The base materials for the poisonous baits may include bait components (e.g., grain powders, vegetable oils, saccharides, and crystalline cellulose) antioxidants (e.g., dibutylhydroxytoluene and nordihydroguaiaretic acid), preservatives (e.g., dehydroacetic acid), agents for preventing children from eating poisonous baits by mistake (e.g., red pepper powders), and attractants (e.g. cheese perfume and onion perfume).

Examples of the surfactants may include alkyl sulfates, alkylsulfonates, alkylarylsulfonates, alkylaryl ethers and their polyoxyethylenated derivatives, polyethyleneglycol ethers, polyvalent alcohol esters and sugar alcohol derivatives.

Examples of the other auxiliaries such as adhesive agents and dispersants include casein; gelatin; polysaccharides such as starch, gum Arabic, cellulose derivatives and alginic acid; lignin derivatives; bentonite; saccharides; and synthetic water-soluble polymers such as polyvinyl alcohol, polyvinylpyrrolidone and polyacrylic acids.

Further, stabilizers including PAP (isopropyl acid phosphate), BHT (2,6-di-tert-butyl-4-methylphenol), BHA (mixture of 2-tert-butyl-4-methoxyphenol and 3-tert-butyl-4-methoxyphenol), vegetable oils, mineral oils, surfactants, fatty acids and fatty acid esters can be utilized as formulation auxiliaries.

In the case the compounds of the present invention are used as an agricultural pesticide, acarid killer or nematocide, they are applied in an amount of usually 0.1 to 100 g for the area of 10 acres. In the case that preparations such as emulsified concentrates, wettable powders or well-flow granules are used after being diluted with water, its application concentration is usually 1 to 100,000 ppm. The granules, dusts and the like are applied without dilution. When the compounds of the present invention are used as a pesticide, acarid killer or nematocide for the prevention of epidemics, the emulsified concentrates, wettable powders, well-flow granules and other formulations are applied after being diluted to 0.1 to 500 ppm with water, but the oil sprays, aerosols, fuming preparations, poisonous baits, acarid-proof sheets and the like are applied in the form as they are.

When the present compounds are used as a pesticide or acaricide for controlling ectoparasites of animals, which are exemplified by agricultural productive livestock such as cattle and pigs, and pets such as cats and dogs, the compounds and salts thereof are used in the veterinary sector by a known systemic method for controlling the pests, for example, by eternal administration, in the form of tablets, capsules, drenches, bolus, the feed-through process and suppositories, by parenteral administration, for example, by means of injections, or by dermal administration, for example, in the form of spraying of oily or aqueous solution, pouring on and spotting on; or by a known non-systemic method using molded articles such as collars or ear marks (tags). In these cases, the compounds of the present invention are applied in an amount of 0.01 to 100 mg per kg body weight of host animals.

The compounds of the present invention may be used as a mixture or individually but simultaneously with present pesticidal composition and the present pesticidal method, the other insecticide, nematocide, acaricide, repellent, fungicide, herbicide, plant growth regulator, synergist, fertilizer, soil improving agent and/or animal foodstuff.

### EXAMPLES

The present invention will be explained in more detail with reference to the following examples in conjunction with the accompanying drawings. However, the following examples are provided only to illustrate the present invention, and the present invention is not limited to the examples.

### Example 1

### Preparation of Compounds Having Inhibitory Effect on Acyl CoA:Cholesterol Acyltransferase

Preparation of Compounds Having Inhibitory Effect on Acyl CoA:Cholesterol Acyltransferase Activity

(1) Penicillium griseofulvum F1959 used in the present invention was isolated from soil collected from Ulsan, Gyeongsangbuk-do, Korea, identified as “Penicillium griseofulvum” by mycological studies, and deposited with KCTC (Korean Collection for Type Cultures) under KRIBB, Korea and assigned accession number of KCTC 0387BP.

Using a frozen stock (10% glycerol, −80° C.) of the isolated fungus, seed culture was performed by inoculation in a 1 L baffle Erlenmeyer flask containing 100 ml of the seed medium: 0.5% glucose, 0.2% yeast extract, 0.5% polypeptone, 0.1% K₂HPO₄, 0.05% MgSO₄.7H₂O (sterilized after being adjusted to pH 5.8), followed by incubation with vigorous agitation at 29° C. for 18 hrs. 20 ml of the first culture was inoculated in a 5 L baffle Erlenmeyer flask containing 1 L of the following culture medium: 2% soluble starch, 0.4% soytone, 0.3% Pharmamedia, 0.1% K₂HPO₄, 0.05% MgSO₄.7H₂O, 0.3% CaCO₃, 0.2% NaCl (sterilized after being adjusted to pH 5.8), and grown with vigorous agitation at 29° C. for 120 hrs.

(2) The fermentation culture broth prepared in the above (1) was extracted with an equal volume of ethyl acetate (EtOAc) with agitation. The ethyl acetate-extracted sample was concentrated under pressure, thus yielding an oil-phased brown extract.

The obtained extract was subjected to silica gel column chromatography (chloroform:methanol=99:1, 98:2, 97:3, 95:5, 90:10 V/V %, 4 volumes compared to silica gel). The fractions were analyzed for distribution of the compounds by thin layer chromatography, and the fractions with same compounds were combined and assayed for inhibitory activity versus acyl CoA:cholesterol acyltransferase. The fractions with the inhibitory activity were combined, and eluted with chloroform/methanol (95:5 to 90:10, V/V %), and the eluates were concentrated under pressure, thus yielding a yellowish brown oil-phased extract.

(3-1) The yellowish brown extract was subjected to high-speed liquid chromatography to obtain an active fraction containing a pyripyropene compound (Formula 1). The high-speed liquid chromatography was performed with an OSD column (20×250 mm) produced by the YMC Company suing an UV detector, where the pyripyropen compound was detected at 322 nm.

The pyripyropen compound, that is, pyripyropen A (Formula 1), was eluted from the OSD column with a solvent of acetonitrile and water (45:55, by volume) and flow rate, 8 ml/minute at 11 min.

The active fraction was concentrated under pressure and purified one more, thus yielding a colorless crystal, pyripropen A (Formula 1). The yield of the compound was 13 mg per fermentation in 1 L medium for 120 hr.

(3-2) Also, active fractions containing the present compounds of the Formulas 2 to 4 were obtained by subjecting the yellowish brown extract prepared in the above (2) to high-speed liquid chromatography. The high-speed liquid chromatography was performed with an OSD column (20×250 mm) produced by the YMC Company suing an UV detector, where the pyripyropen compound was detected at 320 nm.

Phenylpyropene A (Formula 2), phenylpyropene B (Formula 3) and phenylpyropene C (Formula 4) were eluted from the OSD column with a solvent of acetonitrile and water (75:25, by volume) and flow rate, 8 ml/minute at 15 min, 26 min and 49 min, respectively.

Each of the active fractions was concentrated under pressure and purified once more, thus yielding a colorless amorphous crystal, phenylpyropene A (Formula 2), phenylpyropene B (Formula 3) and phenylpyropene C (Formula 4). The phenylpyropene A, B and C were obtained with yields of 2.9 mg, 3 mg and 3.1 mg, respectively, per fermentation in 1 L medium for 120 hr.

Determination of Molecular Structures of the Present Compounds Having Inhibitory Effect on the Sterol Metabolism of Insects

(1) Ultraviolet-Visible Spectroscopy

Ultraviolet-visible light analysis was carried out to determine molecular structures of the compounds obtained by chromatography. In detail, the obtained crystallized compounds were dissolved in 100% methanol, and analyzed for wavelengths corresponding to absorption peaks by using an ultraviolet-visible spectropohtometer (Shimadzu Company, UV-265).

As a result, the compounds showed maximum absorption at 232 nm and 322 nm in the UV range, indicating that the compounds contain a pyridine or phenyl ring.

(2) Infrared Spectroscopy

Infrared (IR) spectroscopy was performed, as follows. 2 mg of each of the obtained crystallized compounds was dissolved in chloroform, smeared on an AgBr window, dried, and analyzed by a BioRad FT/IR spectrophotometer (BioRad Digilab Division, FTS-80).

As a result, the compounds showed absorption peaks around 3550 cm⁻¹, 1740 cm⁻¹ and 1702 cm⁻¹. The IR absorption spectra indicate the presence of OH groups, C═O groups, C═O groups, respectively, in organic compounds.

(3) Mass Spectrometry

In order to determine molecular weights of the compounds, high-resolution mass spectrometry was performed using a mass spectrometer, VGZAB-7070.

As a result, pytipyropene A (Formula 1), phenylpyropene A (Formula 2), phenylpyropene B (Formula 3), phenylpyropene C (Formula 4) and pheophorbide a (Fomula 5) were found to have a molecular weight of 583, 581, 508, 450 and 592, respectively.

(4) NMR Analysis

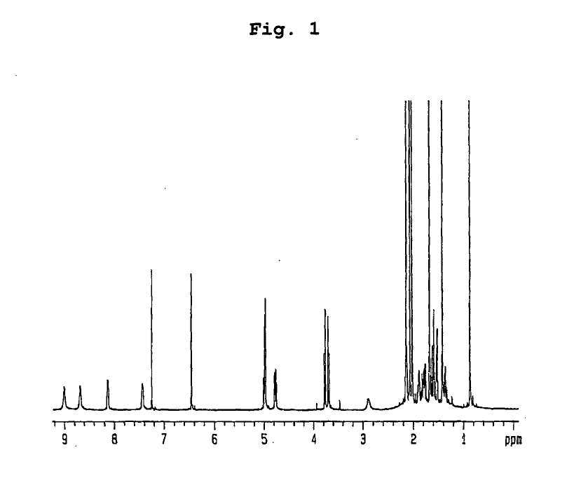

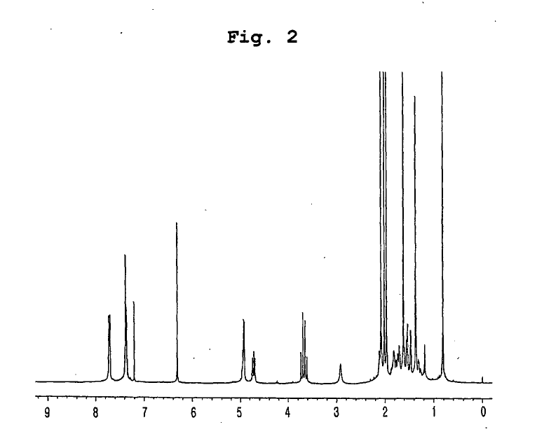

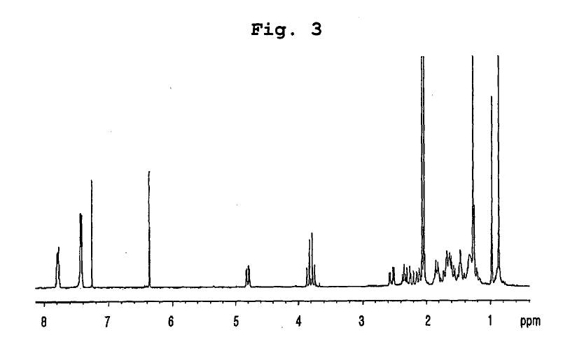

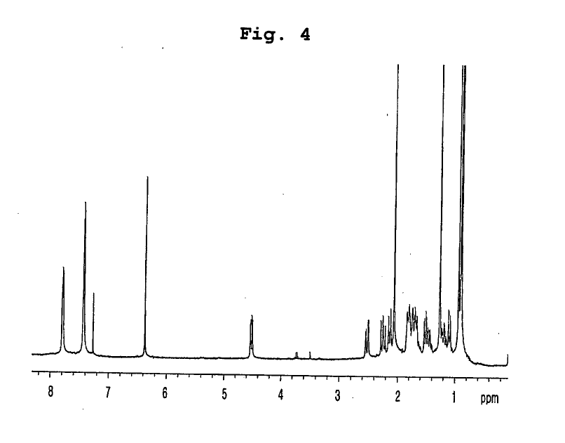

NMR analysis was carried out in order to determine molecular structures of the crystallized compounds. 10 mg of each crystallized compound was completely dried, dissolved in CDCl3, put into a 5-mm NMR tube, and analyzed by using a Varian Unity-500 NMR spectrometer. 1H-NMR spectra were observed at 500.13 MHz. The results are given in FIGS. 1 to 4.

The molecular structures of the compounds of the Formulas 1 to 4 were determined by the analysis of the above (1) to (4).

### Experimental Example 1

### Assay for ACAT Activity of the Compounds of the Present Invention

The compounds of the present invention were evaluated for inhibitory activity versus acyl CoA:cholesterol acyltransferase (hereinafter, referred to as “ACAT”) by the method developed by Brecher with slight modification (Brecher. P and C. Chen, Biochimica Biophysica Acat 617:458-471, 1980). In the method, ACAT activity was determined using hepatic microsomes as a source of ACAT with substrates of cholesterol and ¹⁴C-labeled oleoyl-CoA. The radioactivity of the reaction product cholesterol ester was estimated as the ACAT activity.

In detail, a reaction mixture was prepared as follows. Cholesterol and Triton WR-1339, both dissolved in acetone, were suspended in water, and, after removing acetone in nitrogen gas, supplemented with potassium-phosphate buffer (pH 7.4, final conc.: 0.4 M). To stabilize enzyme reaction, bovine serum albumin was added to the mixture to a final concentration of 30 μM. Then, a sample dissolved in DMSO or methanol was added to the mixture. The resulting reaction mixture was preincubated at 37° C. for 30 min. The enzyme reaction was then initiated by adding [1-¹⁴C]-oleoyl Coenzyme A solution to a final concentration of 0.04 μCi. After 30 min of incubation at 37° C., the reaction was stopped by addition of 1 ml of an isopropanol-heptane solution. Then, 0.6 ml of n-heptane and 0.4 ml of KPB buffer were added to the terminated reaction mixture. The mixture was well mixed and allowed to stand at room temperature for 2 min. After phase separation, 200 μl of the supernatant was put into a scintillation vial. After adding 4 ml of a scintillation cocktail (Lipoluma, Lumac Co.) to the vial, the amount of synthesized cholesteryl oleate was measured with a scintillation counter (Packard Delta-200). The inhibitory activity versus ACAT was calculated according to the following Equation 1:
Inhibitory activity (%)=[1−(T−B/C−B)]×100

wherein,

T: cpm in a test reaction mixture that contains a compound of the present invention along with an enzyme source;

C: cpm in a control reaction mixture that does not contain the compound but contains the enzyme source; and

B: cpm in another control reaction mixture that does not contain the enzyme source but contains the compound.

As a result, pyripyropene A (Formula 1) showed an IC₅₀ value (IC₅₀: compound concentration to inhibit by 50% of ACAT activity) of 35 ng/ml, and the IC₅₀ value was calculated as 0.060 nM because the compound has a molecular weight of 583.

Phenylpyropene A (Formula 2) was found to have an IC₅₀ value of 500 ng/ml, and the IC₅₀ value was calculated as 86 nM because the compound has a molecular weight of 581.

Phenylpyropene B (Formula 3) was found to have an IC₅₀ value of 6.5 μg/ml, and the IC₅₀ value was calculated as 12.8 μM because the compound has a molecular weight of 508.

Phenylpyropene C (Formula 4) was found to have an IC₅₀ value of 7.2 μg/ml, and the IC₅₀ value was calculated as 16.0 μM because the compound has a molecular weight of 450.

Pheophorbide a (Formula 5) was found to have an IC₅₀ value of 1.3 μg/ml, and the IC₅₀ value was calculated as 2.2 μM because the compound has a molecular weight of 592.

In addition, when used in concentrations of 20 μg/ml and 100 μg/ml, the compounds of the Formulas 6 to 11 showed ACAT inhibitory activities of 92.4% and 99.2%; 96.6% and 97.8%; 84.5% and 93.8%; 93.4% and 98.4%; 17.6% and 82.0%; and 84.8% and 89.6%, respectively.

### Experimental Example 2

### Assay for Inhibitory Activity of the Present Compounds Against Plutella xylostella L Larvae

Larvae of Plutella xylostella L was used as an experimental insect in this test, which was obtained from the Insect Research Lab, Korean Research Institute of Bioscience and Biotechnology (KRIBB), Oun-dong, Yusong-ku, Taejon, Korea. After being weighed accurately, a proper amount of the present compounds with an ACAT inhibitory activity were was dissolved in acetone, mixed with nine volumes of a 100 ppm Triton X-100 stock solution, and serially diluted, thus giving active compound solutions. A diet for the growth of the P. xylostella L larvae was prepared, as follows: leaves of cabbages with uniform growth were cut into leaf disks (3.0 cm in diameter), dipped in the active compound solutions for 30 sec, and dried in a hood for 60 min. Each of the active compound-treated leaf disks was put in a petri dish (55×20 mm) with a filter paper disk. Then, 10 second-instar larvae of P. xylostella L were placed on each leaf disc using a soft brush with caution not to damage the larvae, and grown in an incubator (25±1° C., 40-45% relative humidity, 16L:8D) After 24 hrs and 48 hrs, mortality was recorded. A control group was not treated with the active compounds of the present invention, but grown on leaf disks treated with a mixture of 10% acetone and nine volumes of a 100 ppm Trixton X-100 stock solution. This leaf-disk bioassay was performed on three replicates, and LC₅₀ (50% lethal concentration) was calculated by the Probit method developed by Finney (1982).

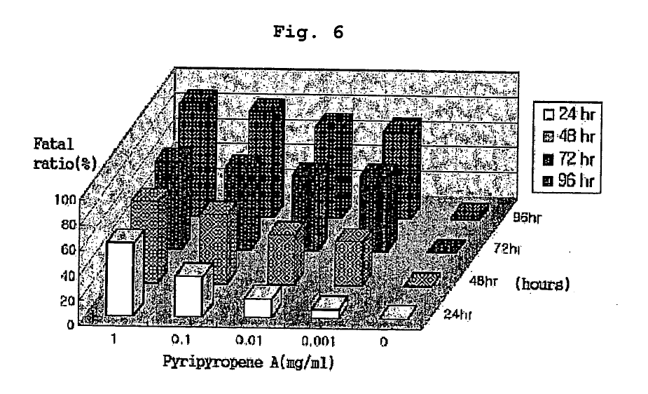

As shown in FIG. 6, when the P. xylostella L larvae were treated with 0.001 to 1 mg of pyripyropene A (Formula 1), among the present compounds with an ACAT inhibitory activity, and the inseticidal activity of the compound was investigated with intervals of 24 hrs, the pyripyropene A showed a lasting insecticidal effect in a dose-dependant manner in comparison with a control.

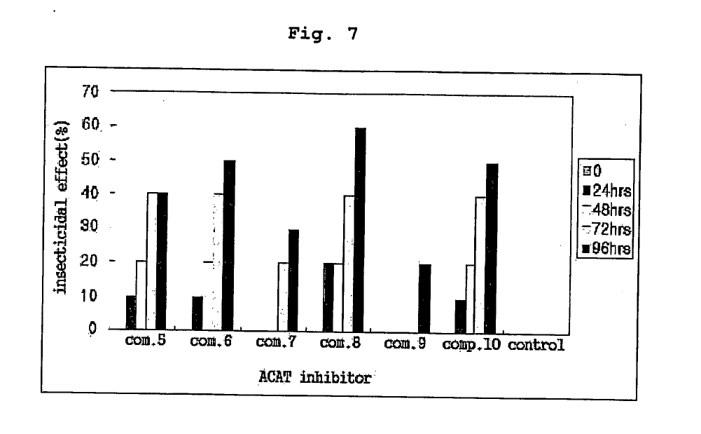

As shown in FIG. 7, when the P. xylostella L larvae were treated with 1 mg of each of the compounds of the Formulas 5 to 11, and the inseticidal activity of the compounds were investigated with intervals of 24 hrs, the compounds with high in vitro ACAT inhibitory activity exhibited strong insecticidal effects, while the compounds with relatively low ACAT inhibitory activity showed weak insecticidal effects, in comparison with each control. These results indicate that the in vitro ACAT inhibitory activity of the compounds correlates with their insecticidal effects.

### Experimental Example 3

### Assay for Inhibitory Activity of the Present Compounds Against Tenebrio molitor L Larvae

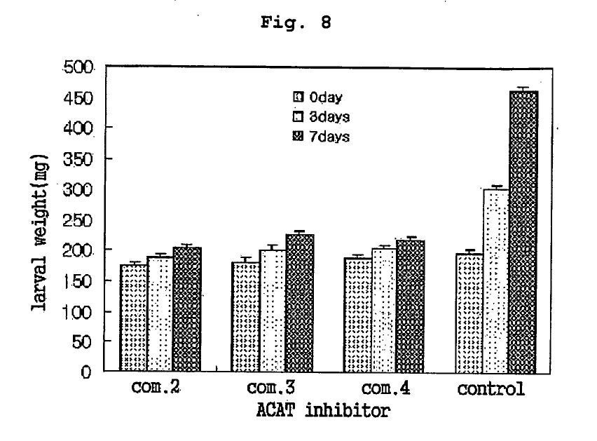

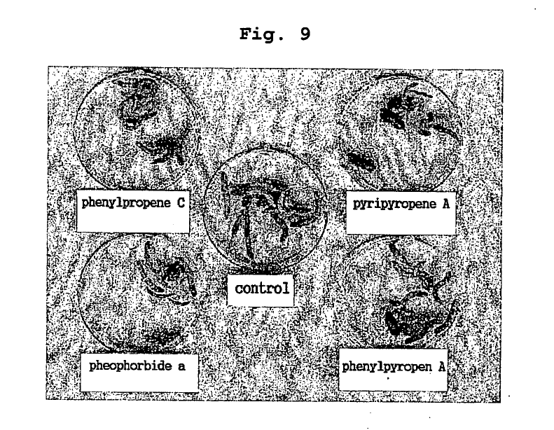

Among the present compounds with an ACAT inhibitory activity, the phenylpyropene A, B and C (Formulas 2 to 4) were tested for weight-reducing effect in larval insects. In this test, larvae of Tenebrio molitor L. was used as an experimental insect, which was obtained from the insect research lab, KRIBB, Korea. Healthy second-instar larvae (10-12 mm) of Tenebrio molitor L was selected 24 hrs before performing this test. Each of the compounds of Formulas 2 to 4 was dissolved in 10% acetone to a final concentration of 1 mg/ml and serially diluted. 1 ml of the diluted compound solution was mixed with 1 g of wheat bran commonly used as a diet. The resulting mixture was put into a glass petri dish (90×20 mm), and the petri dish was placed in a desiccator for about 2 hrs under pressure to remove the organic solvent. After being weighed, 10 highly mobile larvae of T. molitor L for each test set were placed in a petri dish (87×15 mm) with a filter paper disk, together with the mixture of the present compound and wheat bran. Then, the larvae were grown in at 25±1° C. under 40-45% relative humidity with a 16-hour light/8-hours dark cycle. After 72 hrs, larval weight and diet intake were recorded every three days. This assay was performed on three replicates, and a control group was treated with 10% acetone. The results are given in FIGS. 8 and 9.

As shown in FIG. 8, when the T. molitor L larvae were treated with 1 mg of phenylpyropene A, B or C (Formulas 2 to 4) mixed with 10 g wheat bran and larval weight was recorded on day 3 and 7, the compounds showed a lasting larval weight-reducing effect in comparison with each control.

In addition, when the T. molitor L larvae were treated with 1 mg of pyripyropene A (Formula 1), phenylpyropene A and C (Formulas 2 and 4) or pheophorbide a (Formula 5), which each was mixed with 10 g wheat bran, growth inhibitory activity of the compounds was investigated. As shown in FIG. 9, larval growth inhibition was found in all T. molitor L larvae treated with the compounds. In particular, when treated with the pyripyropene A with high ACAT inhibitory activity, most of the T. molitor L insect was killed in the larval and pupa stages, and some were killed by premature eclosion. Also, when treated with other compounds, over 50% of the T. molitor L insect was killed in the larval and pupa stages, while the surviving larvae were growth-inhibited, and the number of the surviving larvae was thus remarkably reduced. Moreover, the surviving larvae were less mobile than a control. These results indicate that the compounds of the present invention have larvicidal effects by inhibiting the growth of the larvae.

### INDUSTRIAL APPLICABILITY

As described hereinbefore, the present invention relates to an insecticidal composition comprising the compounds having an inhibitory effect on ACAT or salts thereof as effective ingredients. The compounds having an ACAT inhibitory activity have an excellent insecticidal effect by inhibiting sterol metabolism in noxious insects. Therefore, the compounds of the present invention can be used as safe and effective insecticides. In addition, some of the compounds having an ACAT inhibitory activity can be easily obtained from Penicillium griseofulvum F1959.

What is claimed is:

1. An insecticidal composition comprising a compound having an inhibitory effect on acyl CoA:cholesterol acytransferase activity or a salt thereof as an effective ingredient.

2. The insecticidal composition according to claim 1, wherein the compound having the inhibitory effect on acyl CoA:cholesterol acyltransferase activity is one or more selected from the group consisting of compounds represented by the following Formulas 1 to 11.

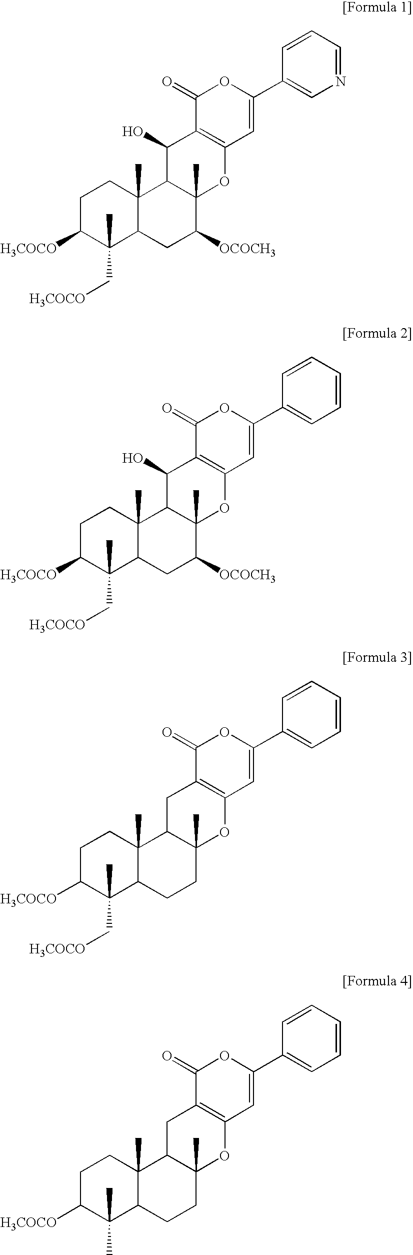

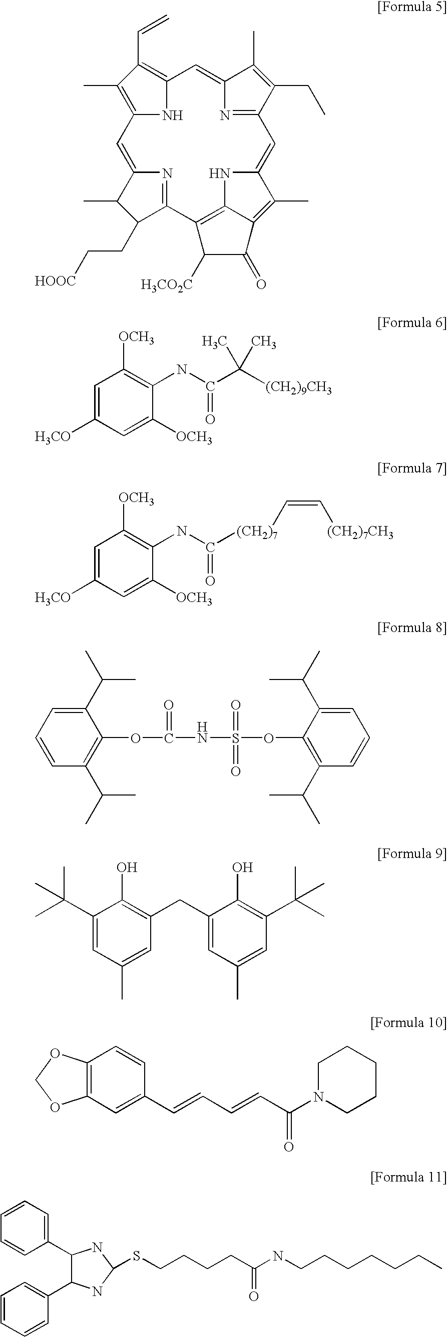

3. The insecticidal composition according to claim 2, wherein the compounds of the Formulas 1 to 4 are prepared by a process comprising:
culturing Penicillium griseofulvum F1959;
extracting the cultured cells with ethyl acetate; and
chromatographing the resulting extract.
